(19) United States
(12) Patent Application Publication
(10) Pub. No.: US 2012/0097677 A1
(43) Pub. Date: Apr. 26, 2012

(54) Hermetic Container

(76) Inventor: Moreno Casoni, Sala Bolognese (IT)

(21) Appl. No.: 13/131,235

(22) PCT Filed: Nov. 25, 2009
(86) PCT No.: PCT/IB2009/007554

§ 371 Date: Sep. 8, 2011

(30) Foreign Application Priority Data
Nov. 26, 2008 (IT) BO2008U000089

(51) Int. Cl. B65D 51/18; B23P 11/00

(52) U.S. Cl. 220/254.8; 220/265; 29/428

(57) ABSTRACT

Hermetic container provided with an upper opening having a longitudinal axis and surrounded by a first folded edge coaxial to the longitudinal axis; and a closing assembly of the upper opening comprising a cap and a connector element; the connector element having a second folded edge coaxial to the longitudinal axis arranged in contact with the first folded edge and an external thread; the cap having an internal thread for screw type coupling with the external thread of the connector element; the closing assembly comprises an adapter which is coaxial to the longitudinal axis and has a third edge folded on the first edge with the interposition of the connector element so as to obtain a reinforced rim.

### TECHNICAL FIELD

The present invention relates to a hermetic container.

In particular, the present invention relates to a hermetic container of the type comprising a cup-shaped body having a longitudinal axis and an upper opening surrounded by a substantially tubular edge, coaxial to the longitudinal axis and protruding in a radial direction towards the outside; and a closing assembly comprising a cap, an annular connector and an adapter.

It is important to stress that such containers may contain, for example, carbonated and still beverages or other food products for which perfect seal of the container is required in order to prevent leakage of the product and guarantee a high level of reliability also in the case of damage and attempted tampering. In addition to ease of assembly in order to reduce production costs and to guarantee good performance in terms of hermetic seal and reliability, there is a growing demand, for this type of container, for satisfactory hygienic protection.

### BACKGROUND ART

So far, carbonated and still beverages (for example fruit juices) have been packed in cans comprising a cup-shaped body and an upper closing wall fitted with an opening device. The opening device substantially consists of a pull-type tab (also known as a tear-off opening) or, according to a widely-used variant (known as a stay on tab), the user of the can, exerting a light pressure, causes tearing of a tab along a previously scored line of separation, with subsequent folding of the tab inside the cup-shaped body.

It is evident that both these opening devices are unable to effectively provide hygienic protection as the beverages and food products inside the cans necessarily come into contact with parts of the closing device on which dust, condensation, pollutants, etc. may accumulate.

### DISCLOSURE OF INVENTION

The purpose of the present invention is to provide a hermetic container that is easy and economical to produce, overcomes the drawbacks of the state of the art and, in particular, guarantees good hygienic protection.

According to the present invention there is provided a hermetic container according to that claimed in the attached claims.

### BRIEF DESCRIPTION OF THE DRAWINGS

The present invention will now be described with reference to the attached drawings which illustrate various non-limiting examples of embodiment, in which:

FIG. 1 is a schematic partial perspective view of a preferred embodiment of the container of the present invention;

FIG. 2 is schematic partial and exploded perspective view of the container of FIG. 1;

FIG. 3 is cross-sectional view of a detail of the container of FIG. 1;

FIG. 4 is a partial cross-sectional view of the container of FIG. 1 in an open position;

FIGS. 5 and 6 are partial cross-sectional views of respective alternative embodiments of the container of FIG. 1 in a closed position.

### BEST MODE FOR CARRYING OUT THE INVENTION

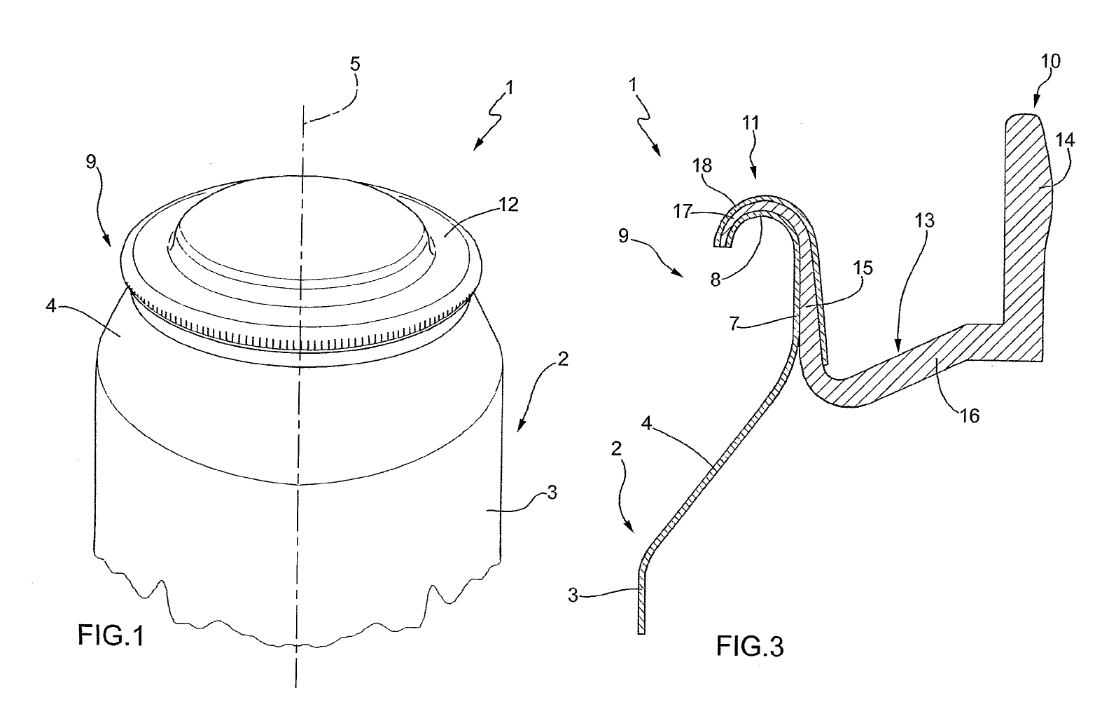

In FIG. 1, numeral 1 indicates as a whole a hermetic container made of metal material in which a containment body 2 has a substantially cylindrical-shaped side wall 3 and a substantially truncated cone-shaped upper annular wall 4.

The containment body 2 has a longitudinal axis 5 and an upper opening 6 which is obtained in the upper wall 4 and is surrounded by a collar 7 of which the upper edge 8 is folded towards the outside.

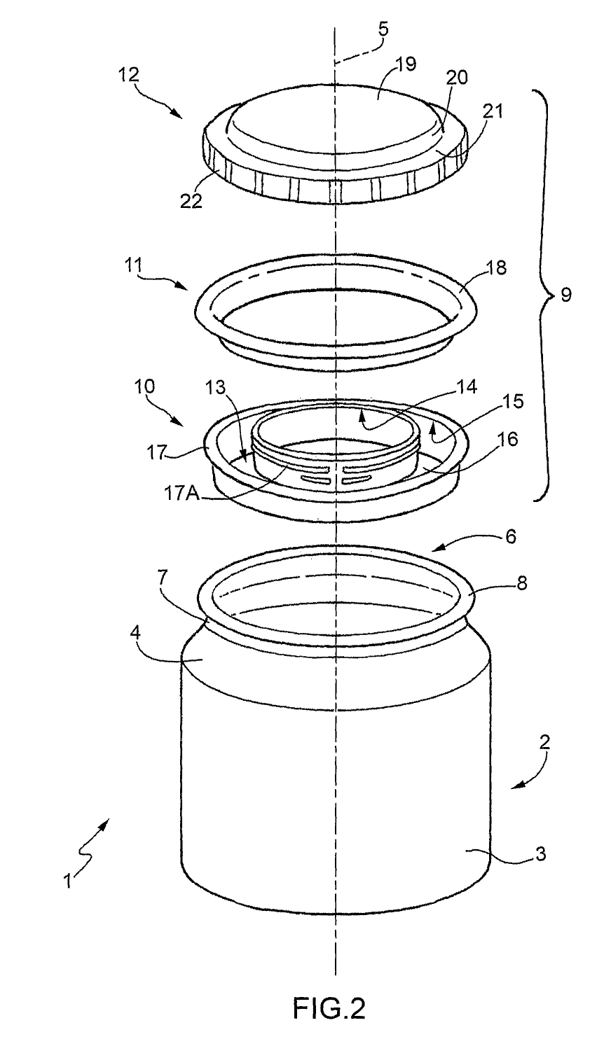

As shown in FIG. 2, to close the upper opening 6, a closing assembly 9 is used comprising a connector element 10 made of plastic material, an adapter 11 made of metal material and a cap 12 also made of plastic material and substantially capsule-shaped.

The connector element 10 is made of plastic material, preferably polypropylene or PET®, is defined by a substantially U-shaped annular body, is coaxial to the longitudinal axis 5 and has an annular cavity 13 facing towards the cap 12 and defined by two side walls, indicated respectively with numerals 14 and 15, which are substantially cylindrical and coaxial to the longitudinal axis 5. The annular cavity 13 is also defined by an annular section of bottom wall 16 which is coaxial to the axis 5, substantially truncated cone-shaped, and acts as connecting element between the two side walls 14, 15.

The external side wall 15 comprises an upper edge 17 folded towards the outside in order to allow coupling with the upper edge 8 of the collar 7.

Also as illustrated in FIG. 2, the connector element also comprises an external thread 17a obtained on the outer surface of the internal side wall 14 in order to allow screw type coupling with the cap 12.

The adapter 11 is made of metal material, is defined by an annular body, is also coaxial to the longitudinal axis 5 and comprises, in turn, an upper edge 18 folded towards the outside in order to allow coupling with the respective upper edges 8, 17 of the collar 7 and of the connector element 10.

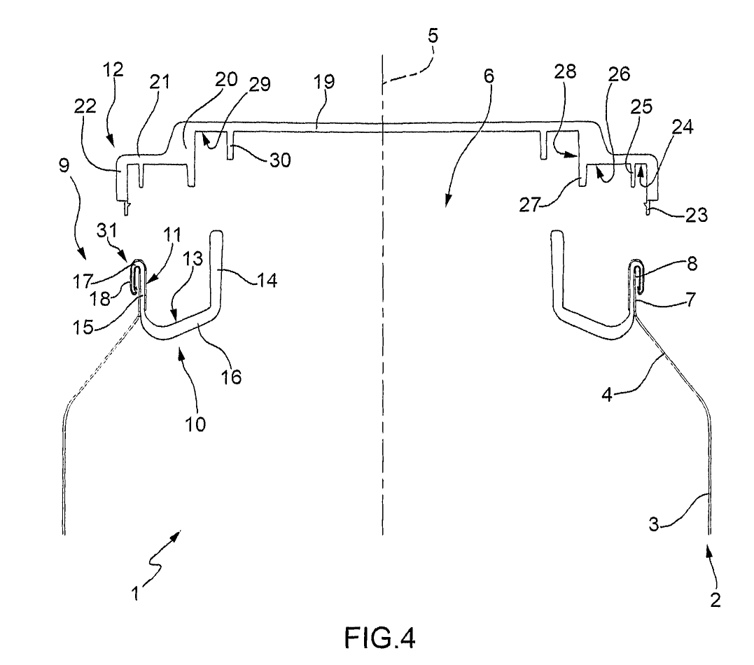

As shown in FIG. 4, the cap 12 comprises an upper wall 19, an annular connection portion 20 coaxial to the longitudinal axis 5 and a section 21 of upper wall, also of annular shape and coaxial to the longitudinal axis 5.

The cap 12 also comprises a substantially cylindrical side wall 22 coaxial to the longitudinal axis 5. At one end facing towards the containment body 2, the side wall 12 is connected to an annular guarantee seal 23 that is torn the first time the container 1 is opened and acts as a safety and protection device against any damage or tampering of container 1.

The cap 12 also comprises a peripheral annular cavity 24, coaxial to the longitudinal axis 5 and defined by the side wall 22 and by an external annular appendix 25 that is coaxial to the longitudinal axis 5, protrudes from a lower surface of the section 21 of upper wall and extends towards the containment body 2.

The cap 12 comprises an intermediate annular cavity 26, coaxial to the longitudinal axis 5 and defined by the external annular appendix 25 and by an annular wall 27, coaxial to the longitudinal axis 5 that protrudes from the annular connection portion 20 towards the containment body 2. The annular connection portion 20 and the annular wall 27 have a common internal cylindrical surface 28.

Lastly, the cap 12 comprises an internal annular cavity 29, coaxial to the longitudinal axis 5 and defined by the internal cylindrical surface 28 and by an internal annular appendix 30 which is coaxial to the longitudinal axis 5, protrudes from a lower surface of the upper wall 19 and extends towards the containment body 2.

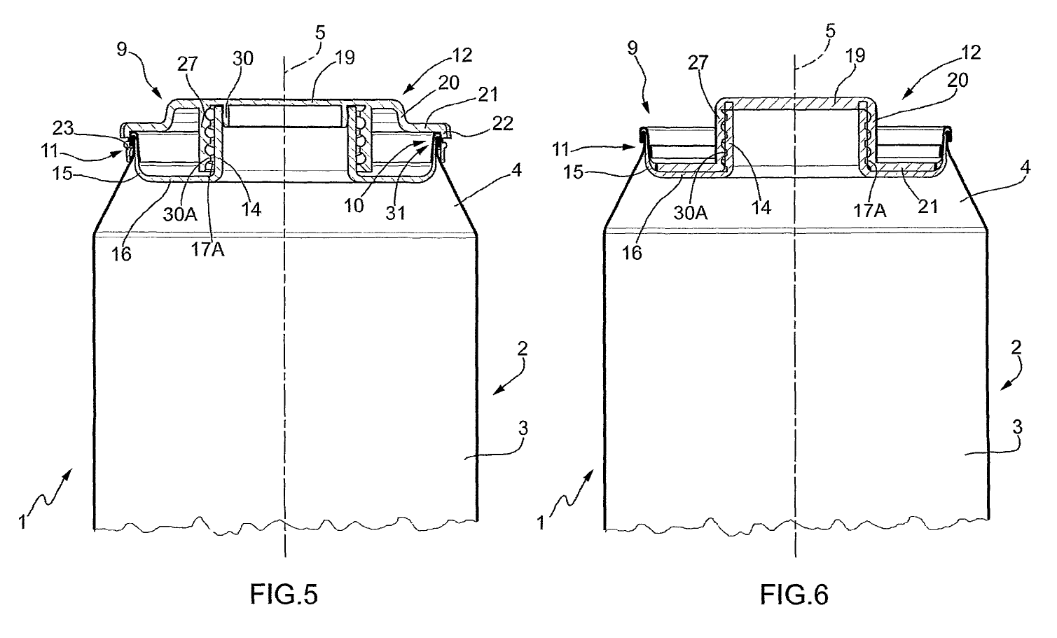

Lastly, the cap 12 has an internal thread 30A (illustrated in FIG. 5) which is obtained on the internal surface 28 and, in use, couples with the external thread 17A of the connector element 10 in order to firmly secure the cap 12 to the containment body 2. The internal annular cavity 29 is aimed at housing, in use, the internal side wall 14 of the connector element 10 in order to improve coupling between the connector element 10 and the cap 12.

In a first step of assembly of the closing assembly 9 on the containment body 2, the connector element 10 is fitted on the collar 7 of the containment body 2 in such a way that the folded upper edge 17 of the connector element 10 comes into contact with the folded upper edge 8 of the collar 7.

In a second step of assembly, the adapter 11 is in turn fitted on the connector element 10 in such a way that the respective folded upper edge 18 comes into contact with the folded upper edge 17 of the connector element 10, as shown in FIG. 3.

After overlapping the two upper folded edges 8, 18 made of metal material (i.e. the folded upper edge 8 of the collar 7 and the folded upper edge 18 of the adapter 11 with the interposition of the upper edge 17 of the connector element 10,) said folded upper edges 8, 18 are crimped.

The two folded upper edges 8, 18 are folded together on each other, by means of crimping, to obtain a stable, hermetically sealed coupling with the interposition of the connector element 10 made of plastic material in such a way as to form a reinforced rib 31, as illustrated in more detail in FIG. 4.

In use, after introducing the product in the container 1 through the upper opening 6, this is closed by screwing the cap 12 on the connector element 10. During application of the cap 12, the guarantee seal 23 is partially deformed, while the reinforced rib 31 engages the annular cavity 24 of the cap 12 until it creates a stable coupling between the elements of the closing assembly 9.

According to an alternative embodiment that is not illustrated, the upper edge 8 of the collar 7 and, consequently, the folded upper edge 17 of the connector element 10 and the folded upper edge 18 of the adapter 11 could be provided selectively with further substantially complementary geometric developments.

The embodiment illustrated in FIG. 5 differs insofar as the cap 12 is without the external annular appendix 25 and, consequently, the peripheral annular cavity 24. Furthermore, the annular wall 27 coaxial to the longitudinal axis 5 protrudes from the upper wall 19 towards the containment body 2.

The embodiment illustrated in FIG. 6 differs insofar as the cap 12 comprises an upper wall 19, an annular connection portion 20, which is substantially cylindrical and coaxial to the longitudinal axis 5 and a section 21 of upper wall, also annular and coaxial to the longitudinal axis 5. The annular connection portion 20 is provided with an internal thread 30A, obtained on an internal surface and, in use, couples with the external thread 17A of the connector element 10 in order to secure the cap 12 firmly to the containment body 2.

Furthermore, the length of the annular connection portion 20 is substantially approximate by defect to the length of the internal side wall 14 of the connector element 10, while the width of the section 21 of upper wall is substantially approximate by defect to that of the section of bottom wall 16 of the connector element 10. In this way, in a closed position of the container 1, the section 21 of upper wall comes into contact with the section of bottom wall 16 of the connector element 10.

The hermetic container 1 described above offers numerous advantages.

First of all, the container 1 described above has good reliability and strength and the hermetic containers 1 can be easily stacked on top of each other thereby facilitating stocking and storage. Furthermore, the closing assembly 9 guarantees good seal of the container 1 and excellent hygiene as the product contained inside said container 1 comes into direct contact with the upper folded edge 18 of the adapter 11; the upper folded edge 18 is protected by the cap 12 against accumulation of dust, condensation, pollutants, etc.

Lastly, the closing assembly 9 permits subsequent use of the hermetic container 1 without affecting the quality of the product it contains, simply keeping the external 17A and internal 30A threads of the components 10 and 12 clean so as not to impair the screw type coupling of said two components 12 and 10 during subsequent usage.

1. Hermetic container comprising:
an upper opening having a longitudinal axis and surrounded by a first folded edge coaxial to the longitudinal axis; and
a closing assembly of the upper opening comprising a cap and a connector element; the connector element having a second folded edge (17) coaxial to the longitudinal axis and in contact with the first folded edge and an external thread; the cap having an internal thread for screw type coupling with the external thread of the connector element;
the container being characterized in that the closing assembly comprises an adapter that is coaxial to the longitudinal axis and has a third edge folded on the first edge with the interposition of the connector element in order to obtain a reinforced rim.

2. Container according to claim 1, wherein said first, second and third edges have substantially complementary shapes.

3. Container according to claim 1, wherein said first, second and third edges are folded towards the outside.

4. Container according to claim 1, wherein the connector element is defined by an annular body coaxial to the longitudinal axis and substantially U-shaped; the connector element having an annular cavity facing towards the cap and comprising an external side wall having the second folded edge.

5. Container according to claim 4, wherein said annular cavity comprises an internal side wall, of substantially cylindrical shape and coaxial to the longitudinal axis; the internal side wall being provided with the external thread to allow screw type coupling with the cap.

6. Container according to claim 5, wherein said annular cavity comprises a section of annular bottom wall, coaxial to the longitudinal axis, of substantially truncated cone shape; the section of annular bottom wall acts as connection element between the two internal and external side walls.

7. Container according to claim 5, wherein the cap comprises an annular inner wall, coaxial to the longitudinal axis, that extends in a downwards direction from an inner surface of the cap; the inner annular wall is provided with the internal thread for screw type coupling with the external thread of the connector element.

8. Container according to claim 7, wherein the cap comprises a first annular cavity defined by the inner annular wall and by an inner annular appendix which is coaxial to the longitudinal axis and protrudes downwards from an inner surface of the cap; the first internal annular cavity being aimed at accommodating, in use, the internal side wall in order to improve coupling between the connector element and the cap.

9. Container according to claim 1 and comprising a product containment body coaxial to the longitudinal axis and comprising a side wall, preferably of cylindrical or truncated cone shape, and the upper opening, surrounded by a collar having the first folded edge.

10. Container according to claim 9, wherein the product containment body is closed by an upper annular wall, preferably of truncated cone shape, in which the upper opening is obtained.

11. Container according to claim 1 wherein the connector element and/or the cap are made of plastic material, preferably polypropylene or PET®.

12. Container according to claim 1 wherein the containment body and/or the adapter are made of metal material.

13. Method for assembly of the hermetic container according to claim 1; the method comprising the following steps:
fitting the connector element on the containment body so that the second edge is in contact with the first folded edge of the containment body;
fitting the adapter on the connector element so that the third edge is in contact with the second edge;
crimping the first and third edges so as to obtain a reinforced rim with the interposition of the second folded edge of the connector element; and
screwing the cap on the connector element in such a way as to create a stable connection between the elements of the closing assembly.
